(19) United States
(12) Patent Application Publication
(10) Pub. No.: US 2017/0095823 A1
(43) Pub. Date: Apr. 6, 2017

(54) PROCESS FOR MANUFACTURING A COATING GUN AND COATING GUN

(71) Applicant: Exel Industries, Epernay (FR)

(72) Inventors: Gilles Goisot, Saint Ismier (FR); Laurent Limbert, Miribel Lanchatre (FR); Philippe Provenaz, Meylan (FR)

(21) Appl. No.: 15/285,494

(22) Filed: Oct. 5, 2016

(30) Foreign Application Priority Data
Oct. 6, 2015 (FR) 15 59490

(51) Int. Cl. B05B 7/12; B05B 1/32; B05B 1/02

(52) U.S. Cl. CPC B05B 7/12; B05B 1/02; B05B 1/32

(57) ABSTRACT

This method serves to manufacture a coating gun, this gun comprising an injector for spraying a round jet along a spray axis and a cap arranged coaxially around the injector, this cap being provided to form an air knife around the jet. This method comprises a step consisting of sizing an axial excess dimension of the injector relative to the cap based on the diameter of the injector. The coating gun comprises an injector for spraying a round jet along a spray axis, a cap arranged coaxially around the injector, provided to form an air knife around the jet. The injector protrudes axially relative to the cap and the axial excess dimension of the injector relative to the cap can be adjusted between a minimum value and a maximum value that are determined based on the diameter of the injector.

### CROSS REFERENCE TO RELATED APPLICATIONS

This application claims priority under 35 USC §119 of French Patent Application No. 15 59490 filed on Oct. 6, 2015.

### FIELD OF THE INVENTION

The invention relates to a process for manufacturing a coating gun, as well as a coating gun.

### BACKGROUND OF THE INVENTION

In the field of spraying a coating product, it is known to use a gun to apply the product. This gun may be of the manual or automatic type and comprises an injector for spraying a product jet along a spray axis. This jet may be flat or round, depending on the type of injector used. The terms “round jet” or “flat jet” injector are then used. A flat jet gives an impact in the form of a very stretched ellipse, while a round jet gives an impact in the form of a ring or disc depending on the pressure of the jet. The invention more particularly applies to gun equipped with a “round jet” injector as described in FR-A-3,009,688.

In a known manner, a “round jet” injector comprises a cap arranged coaxially around the injector and an annular product ejection passage that is centered on the spray axis and that is defined between the cap and the injector. In order to obtain fine spraying in the form of droplets, the gun comprises a so-called compressed air spray circuit, making it possible to expel air in an axial direction around the product jet. This so-called spray air then directly shears the product jet, which makes it possible to atomize the coating product in the form of droplets, the size of which is not homogenous within the jet. At this stage, the jet is very unstable, which is why the gun sometimes comprises a second compressed air circuit, called additional air circuit or “vortex” air circuit, making it possible to expel compressed air around the product jet in a substantially orthoradial direction relative to the spray axis. In this way, the air is expelled around the product jet in a swirling manner, which results in stabilizing the product jet. Furthermore, the droplets of the coating product are confined in a conical volume.

The angle of the cone in which the product jet is confined is proportional to the width of the product jet, and therefore to the diameter of the impact at a given application distance. The angle of the cone can be adjusted by modifying the flow rate and/or the pressure of the air circulating in the “vortex” air circuit. The painter can then adjust the size of the impact on the part to be coated based on the geometry thereof. For example, the painter needs a wider impact for a very expansive part, such as a truck cab, than for a rear-view mirror.

To obtain a fine spray and good aesthetic appearance of the coating, the pressure of the spray air is chosen to be relatively high, particularly when the product to be sprayed is viscous. However, this causes an “overspray” phenomenon that results in spraying product outside the desired impact, and therefore a poorly defined impact geometry, which is why this technique is not usable for very viscous products, for example having a viscosity greater than 120 centipoises. Furthermore, the so-called “vortex” additional airflow is less effective as the spray air pressure becomes higher. Compressed air is then overconsumed in the additional circuit.

### SUMMARY OF THE DESCRIPTION

The invention more particularly aims to resolve these drawbacks by proposing a method making it possible to manufacture a gun capable of spraying a coating product with a well-defined impact and a good aesthetic appearance, without using highly pressurized compressed air in the spray air circuit.

To that end, the invention relates to a method for manufacturing a coating gun, this gun comprising an injector for spraying a round jet along a spray axis and a cap arranged coaxially around the injector, this cap being provided to form an air knife around the jet. According to the invention, the method comprises a step a) consisting of sizing an axial excess dimension of the injector relative to the cap based on the diameter of the injector.

It has been experimentally proven that the value of the axial excess dimension of the injector relative to the cap affects the definition of the impact, for a given injector diameter. Thus, a poorly calibrated gun, i.e., for which the axial excess dimension of the injector relative to the cap is incorrectly dimensioned, does not make it possible to apply a coating having a good aesthetic appearance. To offset this flaw, the tendency is to use highly pressurized compressed air in the spray air circuit, which causes the “overspray” phenomenon mentioned above. However, the gun manufactured using the method according to the invention makes it possible to obtain a well-defined impact without using large quantities of spray air. The impact is well defined because there is little or no overspray phenomenon resulting from the use of highly pressurized compressed air in the spray air circuit. This therefore makes it possible to consume less compressed air in the spray air circuit and it becomes possible to spray particularly viscous products, for example products having a viscosity reaching 160 centipoises. Furthermore, since the impact is well defined, there is less dirtying and therefore less cleaning to be done. Moreover, the additional air flow retains its effectiveness to adjust the diameter of the impact and stabilize the product jet.

According to advantageous, but optional aspects of the invention, the method includes one or more of the following features, considered in any technically allowable combination:

In step a), the excess dimension is selected over an interval defined between a minimum dimension and a maximum dimension that are determined experimentally based on the diameter of the injector.

In step a), the excess dimension is determined based on the width of the jet to be obtained.

In step a), the excess dimension is chosen to be smaller as the jet to be obtained becomes wider.

The ratio between the excess dimension and the diameter of the injector is selected in a surface area defined between a first segment with a zero slope, a second segment with a negative slope, a third segment with a negative slope and smaller, in absolute value, than the slope of the second segment, a fourth segment with a zero slope, a fifth vertical segment, corresponding to an upper limit value for the diameter of the injector, a sixth segment with a negative slope, a seventh segment with a negative slope, and smaller, in absolute value, than the slope of the sixth segment, an eighth segment with a zero slope and a ninth vertical segment, corresponding to a lower limit value for the diameter of the injector.

The invention also relates to a coating gun, comprising an injector for spraying a round jet along a spray axis, and a cap arranged coaxially around the injector, provided to form an air knife around the jet. According to the invention, the injector protrudes axially relative to the cap, while the axial excess dimension of the injector relative to the cap can be adjusted between a minimum value and a maximum value that are determined based on the diameter of the injector.

The value of the axial excess dimension of the injector relative to the cap also affects the definition of the impact for a “round jet” injector. Owing to the new gun, it is therefore possible to adjust the diameter of the impact of the jet sprayed by the gun without modifying the flow rate and/or the pressure of the air circulating in the additional air circuit, which makes it possible to limit the compressed air consumption. The compressed air circulating in the additional air circuit then has a minimal flow rate to stabilize the product jet.

According to advantageous, but optional aspects of the invention, the gun includes one or more of the following features, considered in any technically allowable combination:

The cap is axially translatable relative to a body of the gun.

The gun comprises means for automatically translating the cap relative to the injector.

The cap is screwed on an immobile socket of the gun, the adjustment of the dimension being done by screwing or unscrewing the cap around the spray axis.

The gun comprises means for automatically screwing and unscrewing the cap.

The means comprise a motor, a pinion able to be rotated by the motor and a gearwheel meshing with the pinion and secured in rotation with the cap.

The cap defines a chamber, in which at least one air passage oriented axially and at least one air passage oriented in a substantially orthoradial direction relative to the spray axis emerge.

### BRIEF DESCRIPTION OF THE DRAWINGS

The invention and other advantages thereof will appear more clearly in light of the following description of four embodiments of a gun manufactured using the method according to the invention and a gun according to its principle, provided solely as an example and done in reference to the appended drawings, in which:

FIG. 1 is a side view of a coating gun manufactured using a method according to the invention;

FIG. 2 is a sectional view along line II-II of FIG. 1;

FIG. 3 is a partial sectional view in a plane perpendicular to the plane of FIG. 2;

FIG. 4 is a graph showing an area for selecting an excess dimension of an injector relative to a cap of the gun of FIG. 1, based on the outer diameter of the injector;

FIG. 5 is a diagrammatic sectional illustration of a spray head belonging to a gun according to a second embodiment of the invention;

FIG. 6 corresponds to the spray head of FIG. 5, seen from the outside;

FIG. 7 is a diagrammatic sectional illustration of a spray head belonging to a gun according to a third embodiment of the invention;

FIG. 8 corresponds to the spray head of FIG. 7, seen from the outside;

FIG. 9 is a diagrammatic sectional illustration of a spray head belonging to a gun according to a fourth embodiment of the invention; and

FIG. 10 corresponds to the spray head of FIG. 9, seen from the outside.

### DETAILED DESCRIPTION

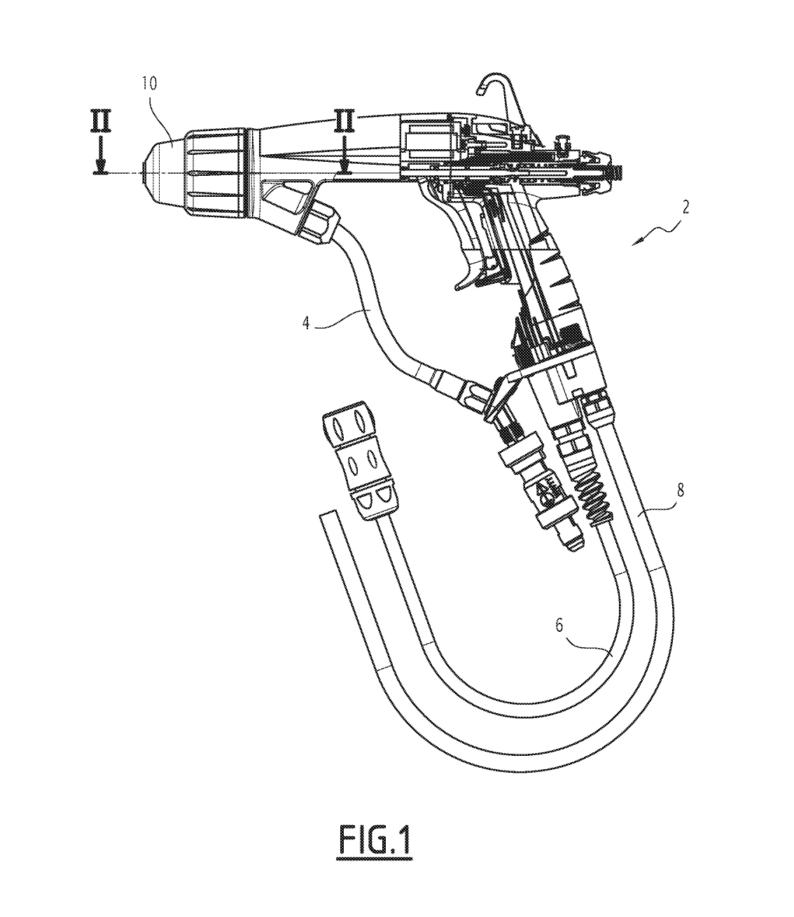

FIGS. 1 to 3 show a coating gun 2 for applying a coating product. In the example, the coating product is paint, in powder or liquid form. Alternatively, it may be a varnish, a solvent, an ink or a lubricant, such as oil.

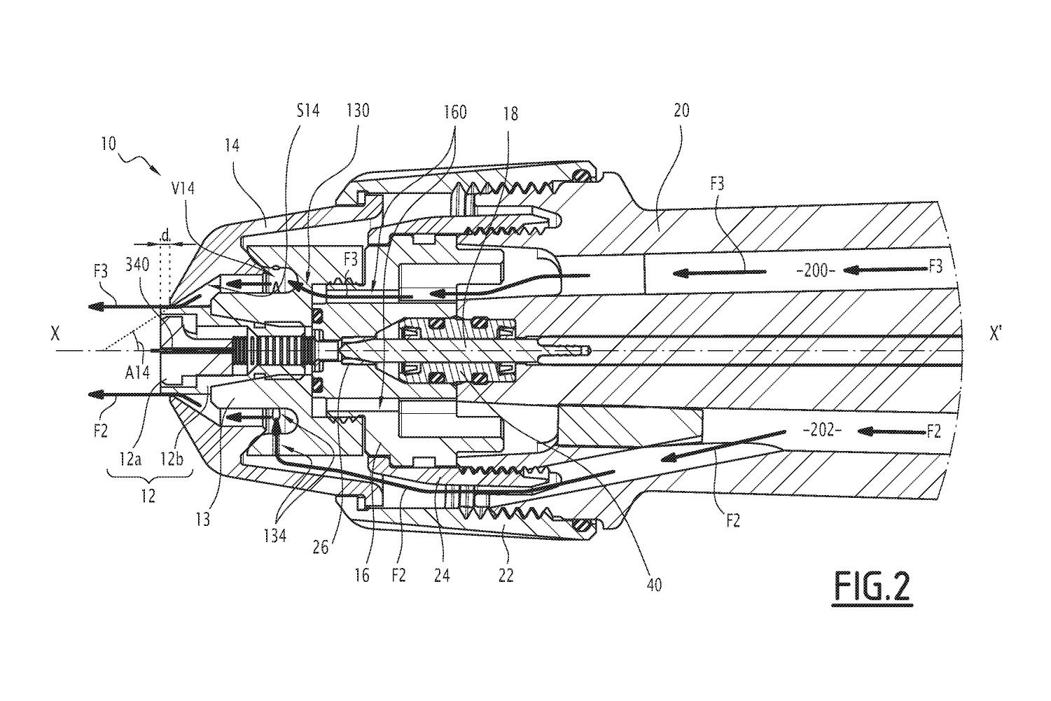

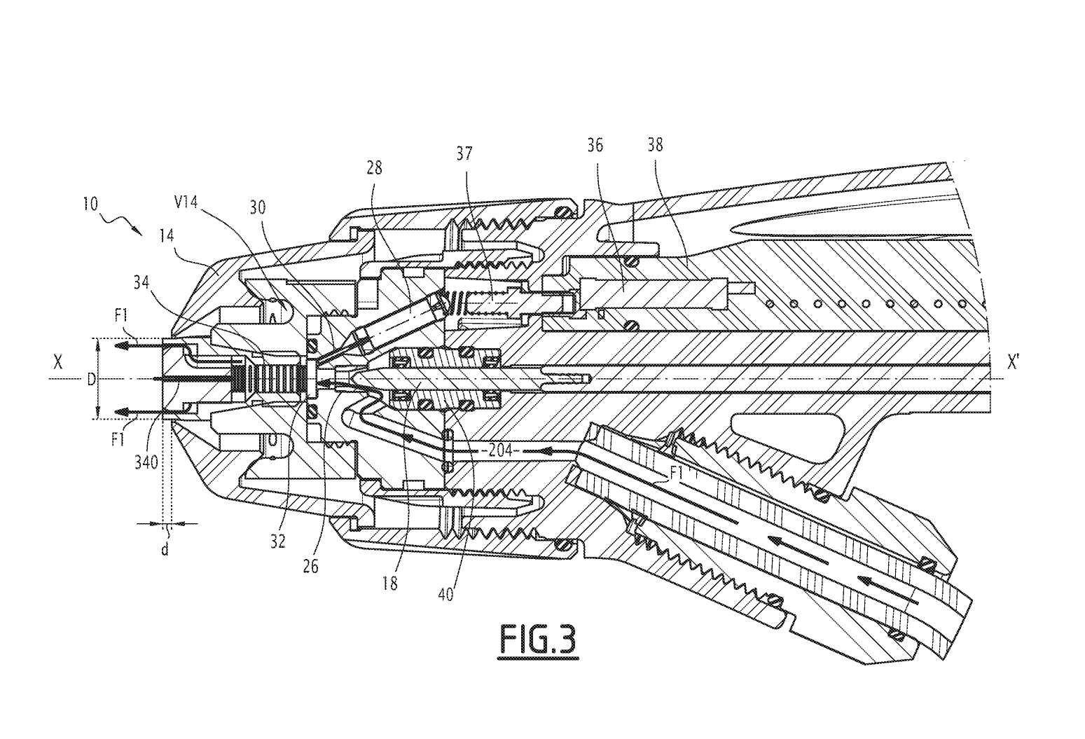

The gun 2 comprises a product supply hose 4, a compressed air supply hose 8 and a power cable 6 for electrostatically charging the product. The gun 2 also comprises a spray head 10, which is better shown in the sectional views of FIGS. 2 and 3.

As shown in FIG. 2, the spray head 10 comprises an injector 12 for spraying a product jet along a spray axis X-X′. The injector 12 is formed by two coaxial parts 12a and 12b that define an annular product ejection passage between them. Thus, the injector 12 is configured to obtain a circular impact. The shape of the impact may be a disc or a ring depending on the pressure of the jet. The injector 12 is therefore a “round jet” injector. D designates the outer diameter of the injector 12.

In the rest of the description, a front direction designates an axial direction, i.e., parallel to the axis X-X′, oriented in the spraying direction, while a rear direction designates an axial direction oriented in the sense opposite the spraying. For example, in FIGS. 2 and 3, the front designates a horizontal direction turned to the left.

The injector 12 is mounted on an injector-holder 13 that is arranged at the rear relative to the injector 12. The injector-holder 13 comprises two coaxial parts that form a single piece.

The gun 2 comprises a so-called spraying compressed air circuit and a so-called additional or “vortex” compressed air circuit. These two circuits travel through a body 20 arranged behind the spray head 10 and emerge in a chamber V14 for forming an air blade around the product jet. This chamber V14 therefore makes it possible to mix the air circulating in the spray air circuit and the air circulating in the additional air circuit. This chamber V14 is defined between the inner coaxial part of the injector-holder 13 and a cap 14 arranged coaxially around the injector 12. The front end of the injector 12 protrudes axially relative to the front end surface of the cap 14 over a distance D, called axial excess dimension of the injector 12, relative to the cap 14.

The cap 14 comprises an inner surface S14 guiding the compressed air toward the outlet, i.e., around the injector 12. This surface S14 is frustoconical and converges, relative to the spray axis X-X′ and in the spraying direction, with a conversion angle A14 comprised between 15° and 60°, in particular equal to 54°.

The injector-holder 13 is screwed on a block 16 that is axially immobilized relative to the rear body 20 using an outer tightening ring 24. This ring 24 is screwed on the rear body 20 and is translatably connected with the block 16 by axial cooperation between an annular end rim belonging to the ring 24 and an outer radial shoulder of the block 16.

A pointer 18 made from a stainless metal alloy is axially movable inside the body 20 and inside the block 16 in contact with a seat 26 housed in the block 16 so as to selectively cut the supply of the injector 12 with coating product. The pointer 18 can also be referred to as a needle. In the configuration of FIG. 2, the needle 18 is in contact with the seat 26, thus cutting the supply of the injector 12 with coating product. The gun 2 comprises a member 40 for guiding the translation of the needle 18 along the axis X-X′. This guide member is a pad 40 that is partially housed inside the block 16 and partially inside the body 20.

The cap 14 is immobilized relative to the body 20 using an outer tightening ring 22. This ring 22 is screwed on the body 20 and is translatably connected with the cap 14 by cooperation between an inner radial lip of the ring 22 and an outer radial rim of the cap 14. More specifically, the ring 22 is screwed around the body 20 until the cap 14 is placed in a tightened, or nominal, position, in which it no longer moves relative to the body 20. In the tightened position, the axial excess dimension d of the injector 12 relative to the cap 14 is fixed. It is then not possible to adjust the dimension d, i.e., to loosen the ring 22, since the cap 14 would then have an axial play detrimental to the operation of the gun 2.

The spray air circuit comprises a conduit 200 traveling through the body 20, axial holes 160 traversing the block 16 and axial holes 130 traversing the injector-holder 13. The axial holes 130 emerge in the mixing chamber V14. The compressed air then comes into the chamber V14 with a substantially axial direction, which is why it is called a “straight” air flow. The journey of the “straight” air flow through the spray head 10 is shown by the arrows F3 in FIG. 2.

The additional air circuit comprises a conduit 202 traveling through the body 20, then between the ring 22 and the ring 24, then around the injector-holder 13. The outer coaxial part of the injector-holder 13 defines through holes 134 that emerge inside the mixing chamber V14. One of these holes 134 is shown in dotted lines in FIG. 2 to facilitate its identification. The holes 134 extend in a plane perpendicular to the spray axis X-X′, in a substantially orthoradial direction relative to the spray axis X-X′, i.e., along a tangential direction relative to a circle centered on the axis X-X′. Thus, the air circulating in the additional air circuit forms a rotational air flow in the mixing chamber V14, which is why it is referred to as a “vortex” air flow. The journey of the “vortex” air flow through the spray head 10 is shown by the arrows F2 in FIG. 2.

Thus, the compressed air forming the outer air blade between the cap 14 and the injector 12 and resulting from the mixing of the “straight” air flow with the “vortex” air flow is oriented in a helical direction around the spray axis X-X′, i.e., swirling. The straight air flow makes it possible to shear the paint jet outwardly, which allows atomization in the form of fine droplets. The “vortex” air flow drives the rotation of the product jet around the spray axis X-X′, which results in stabilizing the jet. The jet is further confined in a conical volume. The “vortex” air flow also determines the diameter of the impact of the gun, i.e., the width of the jet. Thus, the diameter of the impact formed by the jet can be adjusted by modifying the flow rate and/or the pressure of the “vortex” air flow.

As shown in FIG. 3, the rear body 20 defines a conduit 204 for the passage of the coating product. This conduit 204 therefore extends by a conduit defined in the block 16, which emerges in a chamber surrounding the needle 18. In the configuration of FIG. 3, the needle 18 is withdrawn relative to the seat 26, i.e., the needle 18 is in an open position where it does not oppose the passage of the product toward the injector 12. The coating product then circulates inside the injector 12, in particular between the coaxial parts 12a and 12b of the injector 12, and is ejected from the spray head 10 through the annular passage defined between the parts 12a and 12b. The journey of the coating product through the spray head 10 is shown by the arrows F1 in FIG. 3.

The gun is an electrostatic gun, i.e., it comprises means for electrostatically charging the coating product before it is sprayed. The part to be coated is connected to the ground, which generates electrostatic forces making it possible to guide the electrostatically charged droplets of product toward the part. The means for electrostatically charging the droplets are partially shown in FIG. 3. These means include a high-voltage block 38 powered by the cable 6, a first metal resistance 36 connected to the high-voltage block 38 and a second carbon resistance 28 arranged in series with the resistance 36. The electrical connection between the resistances 28 and 36 is provided by an electrical contact 37. The resistance 28 includes a conductive rod 30 that is in contact with a metal bearing washer 32, in the example made from brass, of a metal spring 34. The spring 34 is a spiral-shaped conductor axially inserted between the washer 32 and the inner coaxial part 12a of the injector 12, i.e., it extends in the passage of the coating product. The metal washer 32 is housed in a recess of the block 12. The spring 34 extends, at the front, by a metal wire 340 that traverses the inner coaxial part 12a of the injector 12.

The high-voltage block 38 therefore makes it possible to apply power to the spring 34. The environment surrounding the spring 34, i.e., the air surrounding the spring 34, is then ionized: this is the Corona effect. The metal wire 340 in fact makes it possible to accentuate this Corona effect. The ions generated by Corona effect adhere on the drops of paint circulating inside the injector 12, which results in calibrating the size of the drops: each drop then has substantially the same shape. As an example, there are approximately 6000 ions per drop of paint.

The extra ions, i.e., the ions that are not adhered on the drops of paint, are discharged through the needle 18 toward the earth. There is therefore no accumulation of electrical charges as in a capacitor, which makes it possible to limit the risk of electrocution and fire.

However, the gun 2 comprises a system for absorbing electricity in case of spark. This system comprises the resistance 28, which is provided to absorb, by Joule effect, nearly all of the electricity generated in case of spark and the metal resistance 36, which forms an additional safety bar if the carbon resistance 28 did not absorb all of the electricity.

The gun 2 of FIGS. 1 to 3 is manufactured using a method according to the invention. This method includes a step for sizing the axial excess dimension d of the injector 12 relative to the cap 14.

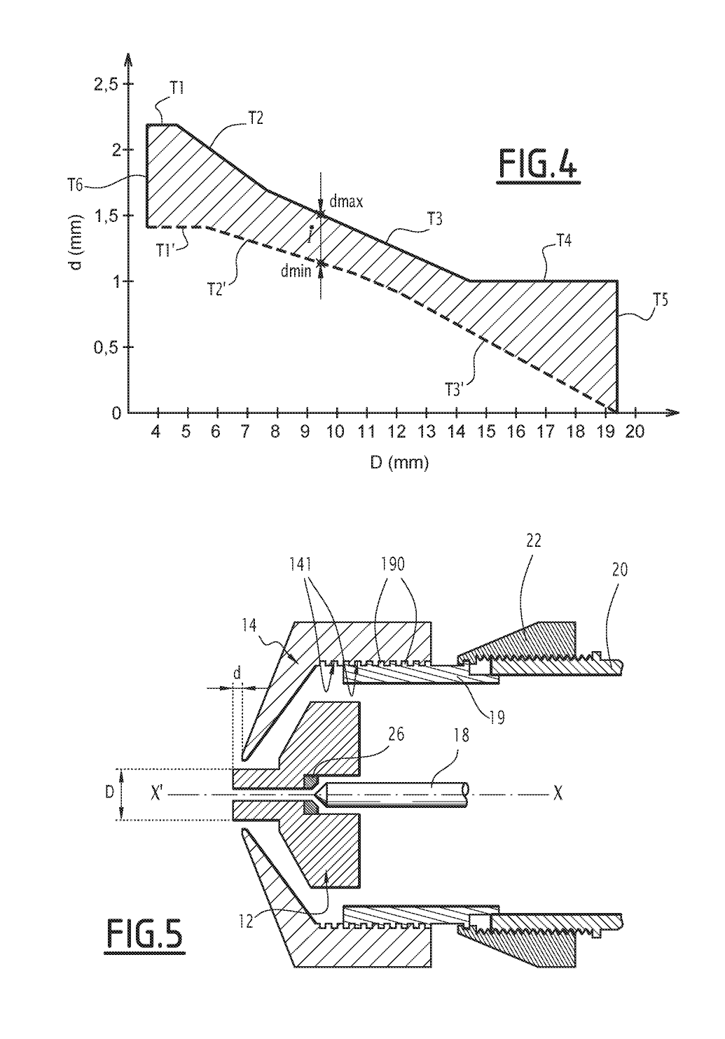

The dimension d indeed affects the definition of the impact and the aesthetic appearance of the coating. More specifically, to obtain a well-defined impact and a good aesthetic appearance for the coating, the dimension d must be selected, for each outer diameter D of the injector 12, over an interval I defined between a minimum dimension dmin and a maximum dimension dmax determined experimentally based on this diameter. As an example, the dimensions dmin and dmax for a diameter D of about 9 mm are designated in FIG. 4. The determination of these minimum and maximum dimensions for different injector diameters yields curves, which are shown in the graph of FIG. 4. As shown in this figure, the diameter D of the injector 12 is calibrated between about 4 mm and 19 mm. Beyond 19 mm, a hollow jet is obtained rather than a round jet. In FIG. 4, the curve in broken lines shows the minimum excess dimension dmin based on the diameter D of the injector 12 and the curve in solid lines shows the maximum excess dimension dmax based on the diameter D of the injector 12. These two curves define an area for selecting the dimension d. This area is crosshatched in FIG. 4 so as to be more visible. When the dimension d is chosen outside this area, the applied coating has a less aesthetically pleasing appearance. The curve of the maximum excess dimension dmax comprises a first segment T1 with a zero slope, for a diameter D comprised between about 4 and 5 mm, a second segment T2 with a negative slope, for a diameter D comprised between about 5 and 8 mm, a third segment T3 with a negative slope that is lower, in absolute value, than that of the segment T2, for a diameter D comprised between about 8 mm and 14 mm, and a fourth segment T4 with a zero slope for a diameter D comprised between about 14 mm and 19 mm.

The curve of the minimum excess dimension dmin comprises a first segment T1′ with a zero slope, for an injector diameter D comprised between about 4 and 6 mm, a second segment T2′ with a negative slope, for an injector diameter D comprised between about 6 and 12 mm, and a third segment T3′ with a negative slope that is higher, in absolute value, than that of the second segment T2′, for a diameter D comprised between about 12 mm and 19 mm. The area is defined between the segments T1, T2 and T3 and the segments T1′, T2′ and T3′ on the one hand, and between two vertical segments T5 and T6 on the other hand. The segments T5 and T6 are infinite slope segments, which respectively correspond to the maximum and minimum limit values for the diameter D of the injector 12. The ratio between the dimension d and the diameter D is selected in this area.

In other words, the ratio d/D is selected, for D comprised between 4 and 19 mm, with a value corresponding to the crosshatched surface in FIG. 4, which is defined between the segments mentioned above.

Thus, a gun manufactured using the method according to the invention makes it possible to obtain a good aesthetic appearance of the coating without using a large quantity of spray air. The impact is well defined because there is little or no overspray phenomenon related to the pressure of the air circulating in the circuit. This makes it possible to reduce the quantity of compressed air by one quarter, or even half, relative to a gun where the dimension d is poorly defined or poorly adjusted and where it is necessary to compensate this poor adjustment by an overconsumption of spray air. Furthermore, since the impact is well defined, there is less dirtying and therefore less cleaning. As an example, cleaning two or even four times less often is sufficient. This also results in savings from 5% to 20% on the quantity of coating product used. Lastly, a low “vortex” air flow rate makes it possible to stabilize the jet and adjust the size of the impact, since the effectiveness of the “vortex” air flow is not altered by the high pressure of the spray air. Moreover, the excess dimension d is determined based on the width of the jet to be obtained, i.e., the desired impact diameter. More specifically, the dimension d is chosen to be smaller as the jet to be obtained becomes wider, and vice versa.

FIG. 5 diagrammatically shows a spray head 10 for a coating gun more improved than that of FIGS. 1 to 3. In the rest of the description, the elements similar to those of the gun illustrated in FIGS. 1 to 3 retain their numerical reference, while the other elements bear other numerical references. In order to be concise, only the differences with respect to the embodiment of FIGS. 1 to 3 are mentioned below.

The dimension d also affects the diameter of the round impact applied on a part. More specifically, the diameter of the impact is wider when the dimension d is chosen to be smaller.

The gun of FIG. 5 differs from that shown in FIGS. 1 to 3 in that the value of the axial excess dimension d of the injector 12 relative to the cap 14 can be adjusted by the painter. Advantageously, the adjustment of the dimension d can be done only between two values: a minimum dimension dmin and a maximum dimension dmax, as considered above.

In the example, a socket 19 including, on its outer surface, a square thread 190 is immobilized relative to the body 20 using a tightening ring 22, which is permanently screwed around the body 20 and which is translatably connected with the ring 22 by cooperation between an outer collar of the socket 19 and an inner lip of the ring 22. The cap 14 comprises slots 141 complementary to the square thread 190 of the socket 19. The cap 14 can therefore be more or less screwed around the immobile socket 19, based on the desired dimension d. It is therefore possible to adjust the dimension d based on the desired impact diameter, without harming the proper operation of the gun. Advantageously, the square thread 190 of the socket 19 is sized to move the cap 14, along the axis X-X′, between a withdrawn position and a deployed position. In the deployed position, the axial excess dimension d of the injector 12 relative to the cap 14 corresponds to the minimum acceptable dimension dmin, whereas in the withdrawn position, the dimension d corresponds to the maximum acceptable dimension dmax. Thus, the painter does not risk making the gun operate in downgraded mode by selecting a dimension smaller than the minimum acceptable dimension dmin, or larger than the maximum acceptable dimension dmax.

Thus, to increase the width of the impact, the painter unscrews the cap 14 to reduce the dimension d, and to reduce the size of the impact, the painter screws the cap 14 to increase the excess dimension d of the injector 12 relative to the cap 14. The size of the impact can then be adjusted without using an additional so-called “vortex” air jet.

The method for manufacturing the gun of FIG. 5 advantageously comprises a step consisting of adjusting the dimension d, as well as the minimum and maximum dimensions dmin and dmax.

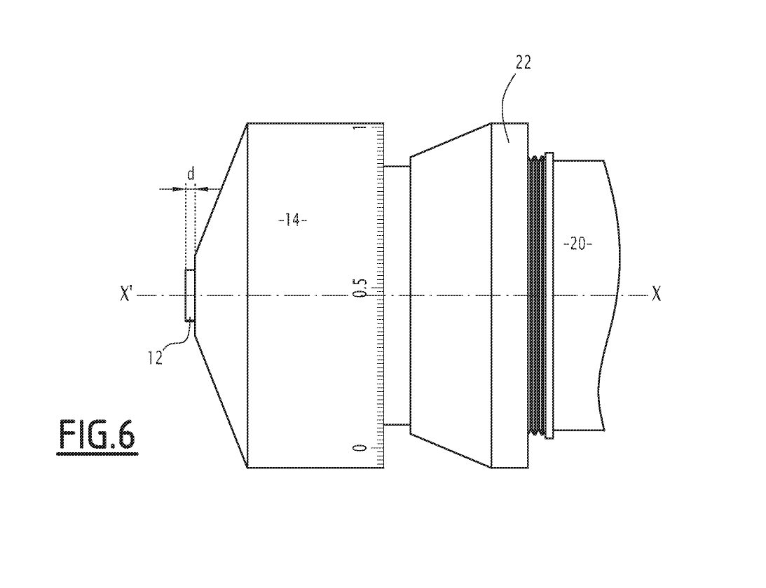

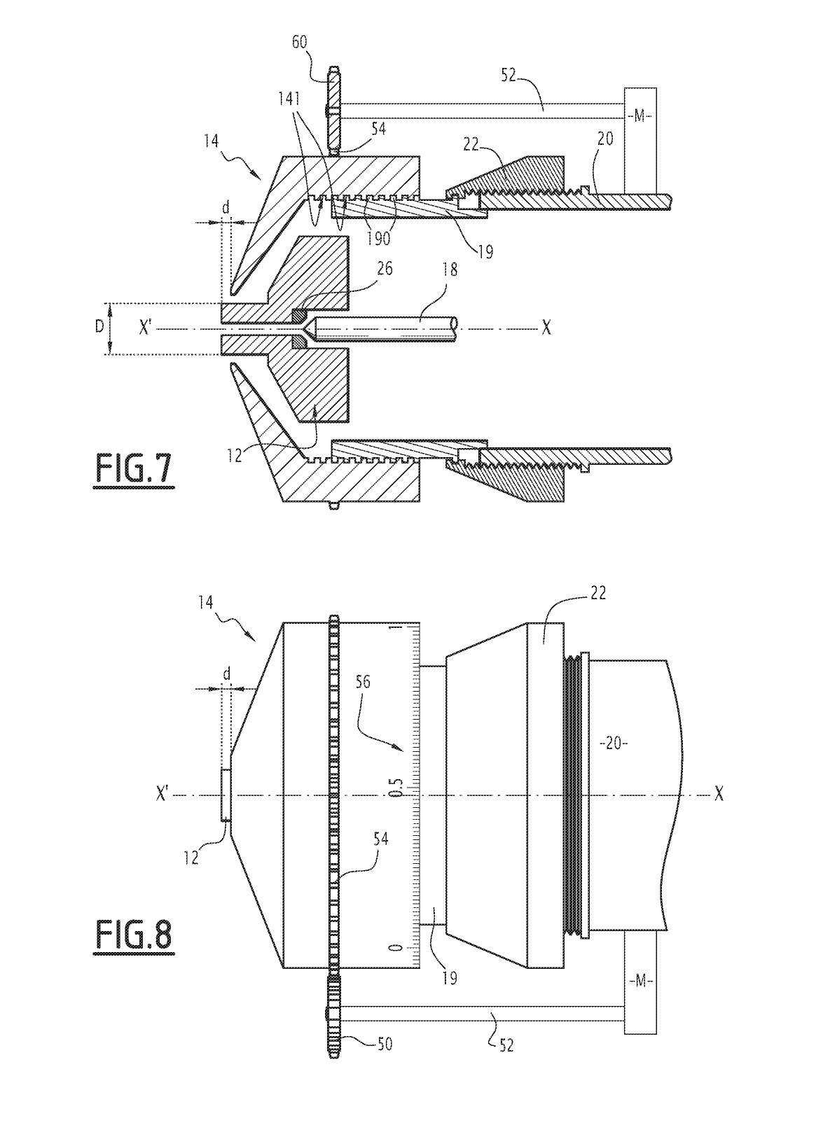

FIGS. 7 and 8 show a third embodiment of the invention. In the rest of the description, the elements similar to those of the gun illustrated in FIGS. 5 and 6 retain their numerical reference, while the other elements bear other numerical references. In order to be concise, only the differences with respect to the embodiment of FIGS. 5 and 6 are mentioned below.

The gun of FIGS. 7 and 8 differs from that of FIGS. 5 and 6 in that the adjustment of the dimension d is done automatically, and no longer manually. Indeed, the spray head comprises automatic adjusting means for the excess dimension d of the injector 12 relative to the cap 14. These means comprise a motor M mounted on the outer surface of the body 20, a pinion 50 driven by the motor M using a transmission shaft 52 and a gearwheel 54, which meshes with the pinion 54 and is secured in rotation with the cap 14. Thus, the rotation of the motor M automatically drives the rotation of the cap 14 and the movement of the cap 14 parallel to the axis X-X′.

Advantageously, the motor M is a pneumatic motor, but it can also be an electric motor, for example a stepping motor.

Furthermore, a graduation 56 inscribed on the outer surface of the cap 14 allows the painter to know the value of the excess dimension d of the injector 12 relative to the cap 14. This graduation extends peripherally around the spray axis X-X′.

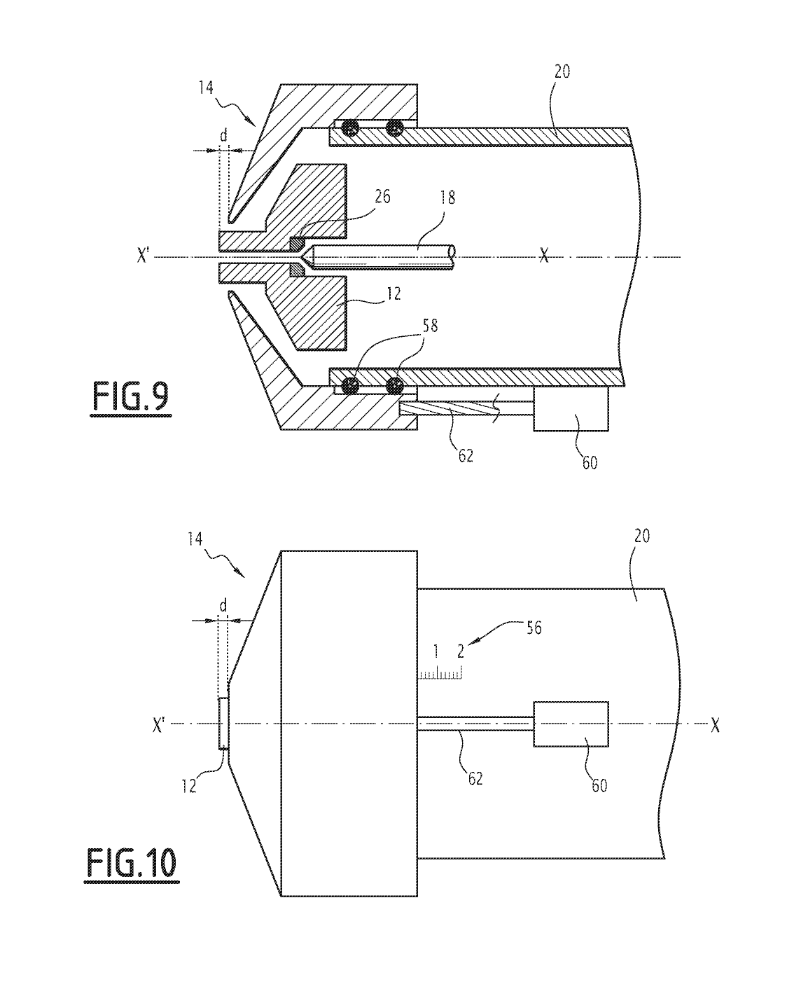

FIGS. 9 and 10 show a fourth embodiment of the invention. In the rest of the description, the elements similar to those of the gun illustrated in FIGS. 7 and 8 retain their numerical reference, while the other elements bear other numerical references. In order to be concise, only the differences with respect to the embodiment of FIGS. 7 and 8 are mentioned below.

The gun according to the forth embodiment differs from that of the second and third embodiments by the fact that the cap 14 is mounted sliding relative to the body 20 of the spray head 10. More specifically, the cap 14 can be translated along the spray axis X-X′ and is immobile in rotation around this axis X-X′. In the example, beads 58 make it possible to roll the cap 14 around the body 20.

The gun comprises means for automatically translating the cap 14 relative to the injector 12. These means include a cylinder 60, which is fastened on the outer surface of the body 20. This cylinder may be of the pneumatic or electric type and actuates a cylinder rod 62, which is fastened by one of its ends to the cap 14.

A graduation 56 is inscribed on the outer surface of the body 20. This graduation 56 indicates the value of the selected dimension d to the painter. This graduation 56 forms outside means for identifying the dimension d by which the injector 12 protrudes relative to the cap 14.

The automatic gun of FIGS. 7 to 10 is designed to equip an installation for automatically applying a coating product on conveyed parts, such as vehicle bodies. The diameter of the impact of the sprayer can be adjusted digitally by an operator, for example by acting on a computer, based on the gauge of the part to be coated.

The diameter of the impact of the sprayer can also be adjusted automatically, in which case the installation comprises a gauge detector for the conveyed parts and an electronic control unit. Such an installation is for example described in FR 1,551,330. The electronic control unit then adjusts the dimension d of each gun based on the gauge of the part and/or the position of the gun on its trajectory.

In an alternative that is not shown, another system may be used to adjust the excess dimension d. In particular, the system may make it possible to move the injector 12 relative to the cap 14.

In an alternative that is not shown, applicable to the forth embodiment, the cap 14 is moved manually relative to the injector 12, i.e., the gun does not comprise means for moving the cap 14 automatically. The painter then manipulates the cap 14 directly with his hands. To that end, the gun comprises means for blocking the translation of the cap 14 when the painter has reached the desired dimension d value. These means are for example formed by a non-return click system.

In an alternative that is not shown, the interval I over which the dimension d is chosen is defined between a minimum dimension dmin and a maximum dimension dmax that are determined digitally based on the diameter D of the injector 12.

The features of the embodiments and alternatives considered above can be combined to create new embodiments of the invention. In particular, the gun of the embodiment of FIGS. 1 to 3 can be modified to be able to adjust the excess dimension d of the injector 12 relative to the cap 14, manually as in FIGS. 5 and 6 or automatically as in FIGS. 7 to 10.

1. A method for manufacturing a coating gun, this gun comprising an injector for spraying a round jet along a spray axis and a cap arranged coaxially around the injector, this cap being provided to form an air knife around the jet, this method comprising a step a) consisting of sizing an axial excess dimension of the injector relative to the cap based on a diameter of the injector.

2. The method according to claim 1, wherein, in step a), the axial excess dimension is selected over an interval defined between a minimum dimension and a maximum dimension that are determined experimentally based on the diameter of the injector.

3. The method according to claim 1, wherein, in step a), the axial excess dimension is determined based on the width of round the jet to be obtained.

4. The method according to claim 3, wherein, in step a), the axial excess dimension is chosen to be smaller as the round jet to be obtained becomes wider.

5. The method according to claim 1, wherein the ratio between the axial excess dimension and the diameter of the injector is selected in an area defined between:
a first segment with a zero slope,
a second segment with a negative slope,
a third segment with a negative slope that is lower, in absolute value, than the slope of the second segment,
a fourth segment with a zero slope,
a vertical fifth segment, corresponding to an upper limit value for the diameter of the injector,
a sixth segment with a negative slope,
a seventh segment with a negative slope that is lower, in absolute value, than the slope of the sixth segment,
an eighth segment with a zero slope, and
a vertical ninth segment, corresponding to a lower limit value for the diameter of the injector.

6. A coating gun for applying a coating product, comprising:
an injector for spraying a round jet along a spray axis,
a cap arranged coaxially around the injector, provided to form an air knife around the jet,
wherein the injector protrudes axially relative to the cap, and wherein the axial excess dimension of the injector relative to the cap can be adjusted between a minimum value and a maximum value that are determined based on a diameter of the injector.

7. The coating gun according to claim 6, wherein the cap is axially translatable relative to a body of the gun.

8. The coating gun according to claim 7, wherein the gun comprises means for automatically translating the cap relative to the injector.

9. The coating gun according to claim 6, wherein the cap is screwed on an immobile socket of the gun, the adjustment of the axial excess dimension being done by screwing or unscrewing the cap around the spray axis

10. The coating gun according to claim 9, wherein the gun comprises means for automatically screwing and unscrewing the cap.

11. The coating gun according to claim 10, wherein the means comprise a motor, a pinion able to be rotated by the motor and a gearwheel (meshing with the pinion and secured in rotation with the cap.

12. The coating gun according to claim 6, wherein the cap defines a chamber, in which at least one air passage oriented axially and at least one air passage oriented in a substantially orthoradial direction relative to the spray axis emerge.
